(19) United States
(12) Patent Application Publication
(10) Pub. No.: US 2026/0295686 A1
(43) Pub. Date: Oct. 1, 2026

(54) VALVE COVER REPAIR TOOL

(71) Applicant: Milton Industries, Inc., Chicago, IL (US)

(72) Inventor: Jeffrey Del Rossa, Chicago, IL (US)

(73) Assignee: Milton Industries, Inc., Chicago, IL (US)

(21) Appl. No.: 19/578,124

(22) Filed: Mar. 25, 2026

Related U.S. Application Data
(60) Provisional application No. 63/778,792, filed on Mar. 27, 2025.

(51) Int. Cl. B23B 47/28; B25B 27/18

(52) U.S. Cl. CPC B23B 47/284; B25B 27/18

(57) ABSTRACT

A valve cover repair tool is provided. The tool allows a user to remove a broken hold down bolt from an engine valve cover without damaging the valve cover. The valve cover repair tool has an elongated neck portion and a generally circular expander flange portion. An alignment hole may be located on the elongated neck portion. A screw and an expander nut may be secured within the generally circular expander portion. When the nut is turned, the expander flange may expand within an opening of a valve cover. Once the tool is secured, a drill is then used in the alignment hole to remove the broken hold down bolt.

### CROSS REFERENCE TO RELATED APPLICATIONS

The present application is based on and claims the benefit of U.S. Ser. No. 63/778,792 filed Mar. 27, 2025; the entire contents of which are incorporated herein.

### BACKGROUND OF THE INVENTION

A valve cover repair tool is provided. The tool allows a user to remove a broken hold down bolt from an engine valve cover without damaging the valve cover. The valve cover repair tool has an elongated neck portion and a generally circular expander flange portion. An alignment hole may be located on the elongated neck portion. A screw and an expander nut may be secured within the generally circular expander portion. When the nut is turned, the expander flange may expand within an opening of a valve cover. Once the tool is secured, a drill is then used in the alignment hole to remove the broken hold down bolt.

Devices to remove broken bolts are known. For example, U.S. Pat. No. 10,227,960 to Del Rossa discloses an improved apparatus for repairing fuel injector hold-down bolt holes is disclosed. The apparatus can be readily mounted to the passage through which the fuel injector passes via a flange that fits inside the passage and thus generally avoids the need to remove the engine in order to conduct the repairs. The apparatus further provides guides or bushings that allow for the precise alignment of various tools to repair the hold-down bolt hole.

Further, U.S. Pat. No. 7,819,613 to Storm discloses a self-tapping insert installed in a pre-existing bore hole in a workpiece by rotating the insert, causing cutting threads on the exterior of the self-tapping insert to cut new threads. Engagement threads on the exterior of the self-tapping insert engage the new threads to retain the self-tapping insert within the workpiece. The self-tapping insert may comprise internal threads which are used to replaced damaged threads in the workpiece. The exterior threads of the self-tapping insert may be configured as left-handed threads, while the internal threads are right-handed threads. The top of the self-tapping insert may comprise a plurality of castellations, and a drive head having matching castellations may be employed to install the self-tapping insert, eliminating the need for installing the insert with a drive bolt. The exterior of the self-tapping insert may further comprise a leading edge for cutting the new threads, where the leading edge has greater radial extension than the trailing edge. This feature provides greater chip relief, thereby reducing the torque required to install the self-tapping insert.

However, these patents fail to describe a valve cover repair tool which is easy to use as the present device. Further, these patents fail to provide for a valve cover repair tool which allows user to remove a broken fuel injector hold down bolt in a quick and efficient manner without damaging the valve cover.

### SUMMARY OF THE INVENTION

A valve cover repair tool is provided. The tool allows a user to remove a broken hold down bolt from an engine valve cover without damaging the valve cover. The valve cover repair tool has an elongated neck portion and a generally circular expander flange portion. An alignment hole may be located on the elongated neck portion. A screw and an expander nut may be secured within the generally circular expander portion. When the nut is turned, the expander flange may expand within an opening of a valve cover. Once the tool is secured, a drill is then used in the alignment hole to remove the broken hold down bolt.

An advantage of the present valve cover repair tool is that present valve cover repair tool allows a user to remove a broken hold down bolt from an engine valve cover without damaging the valve cover.

Unlike most automotive applications that use plastic, the Ford Power Stroke 6.7 L and GM Duramax 6.6 L Diesel engines incorporate cast aluminum valve covers. Aluminum is chosen due to the extreme torque required to secure the fuel injectors. Power Stroke was first introduced in 2011 where the Duramax was 2001. Over time, aluminum will corrode producing imperfections in the surface, more commonly known as “pits” or “blisters”. When paired with a dissimilar material, corrosive activity is accelerated, and the formation of blisters can become more prevalent. In applications where there is a close fit or in proximity of another part, the two parts can become bonded together. Such is the case in this example and the resulting product development, Valve Cover Repair Kit, or VCR as indicated in the drawing.

Both engines incorporate eight zinc plated fuel injector hold-down bolts that pass through the valve cover and are secured into the cylinder head. The corrosive action of both dissimilar metals, the exposure to moisture, salt, and other contaminates along with the close tolerance of bolt to valve cover will cause the hold down bolt to become bonded to the valve cover and unable to be removed. When a technician attempts to remove the hold-down bolt(s) to service the fuel injectors (about every 60-80 k miles) it can become difficult or impossible (destroying the valve cover) to remove resulting in fracturing the injector hold down bolt. To access or remove a fractured hold-down bolt, the value cover must be removed to make the repair. The removal and replacement of a valve cover book time in both applications is about 3 hours. A broken bolt can elongate it to well over 28 hours. There are currently tools to remove a broken hold down bolt from the cylinder head; however, there isn't a tool currently in the market to remove the bolt from the valve cover.

The present device is designed to remove the broken bolt from the valve cover without damaging the cover. The width of the tool is limited so as to fit inside the hold down bolt valley using the side walls of the valley to register it (align). This in combination with the expandable nylon flange and stainless-steel arbor (PAT NICO U.S. Pat. No. 10,227,960 B2 for GM, NINO US PATENT D779,923 S for Power Stroke) which will seat and be secured the tool into the injector passage. This will allow a technician to accurately align the tool (jig) and facilitate drilling the damaged fastener. The device uses existing off our shelf PMX designed and produced parts with the exception of the red aluminum anodized plate.

For a more complete understanding of the above listed features and advantages of the valve cover repair tool reference should be made to the detailed description and the drawings. Further, additional features and advantages of the invention are described in, and will be apparent from, the detailed description of the preferred embodiments.

### BRIEF DESCRIPTION OF THE DRAWINGS

FIG. 1 illustrates a top perspective view of the valve cover repair tool.

FIG. 2 illustrates a bottom perspective view of the valve cover repair tool.

FIG. 3 illustrates an exploded perspective view of the valve cover repair tool with a drill present.

FIG. 4 illustrates a top perspective view of the valve cover repair tool with the screw, flange and nut removed.

FIG. 5 illustrates a perspective view of the valve cover repair tool being inserted over a broken bolt and with a drill illustrated with the circular drill alignment piece removed for illustrative purposes and with the screw, nut and expander flange removed for illustrative purposes.

FIG. 6 illustrates a top view of the expanding flange.

FIG. 7 illustrates a side view of the expanding flange.

FIG. 8 illustrates a bottom view of the expanding flange.

FIG. 9 illustrates a view of the tool secured to the engine valve cover.

FIG. 10 illustrates a side view of the tool secured to an engine valve cover.

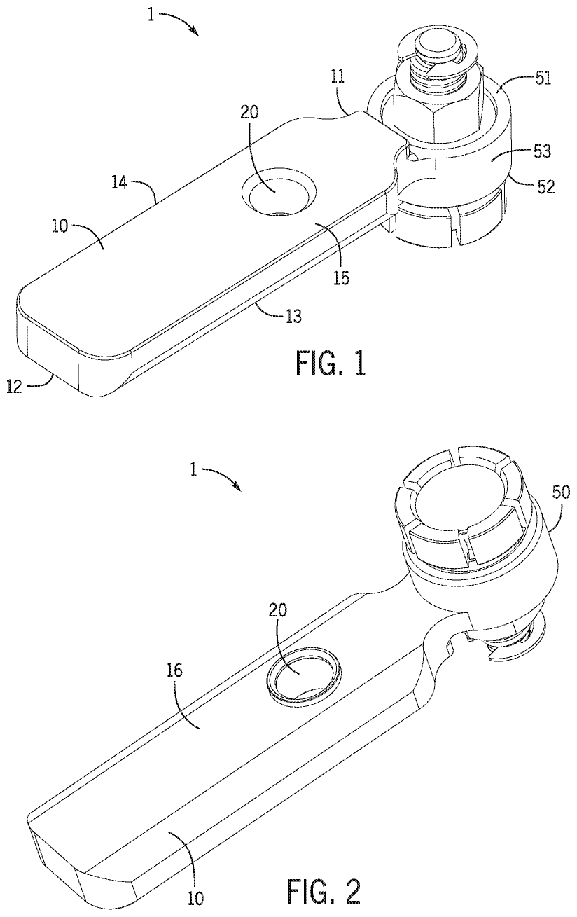

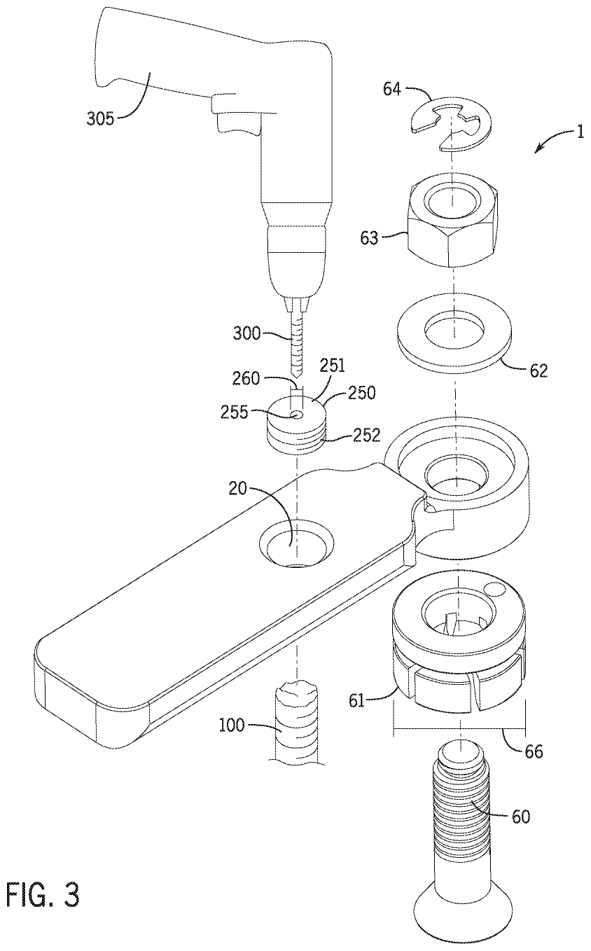

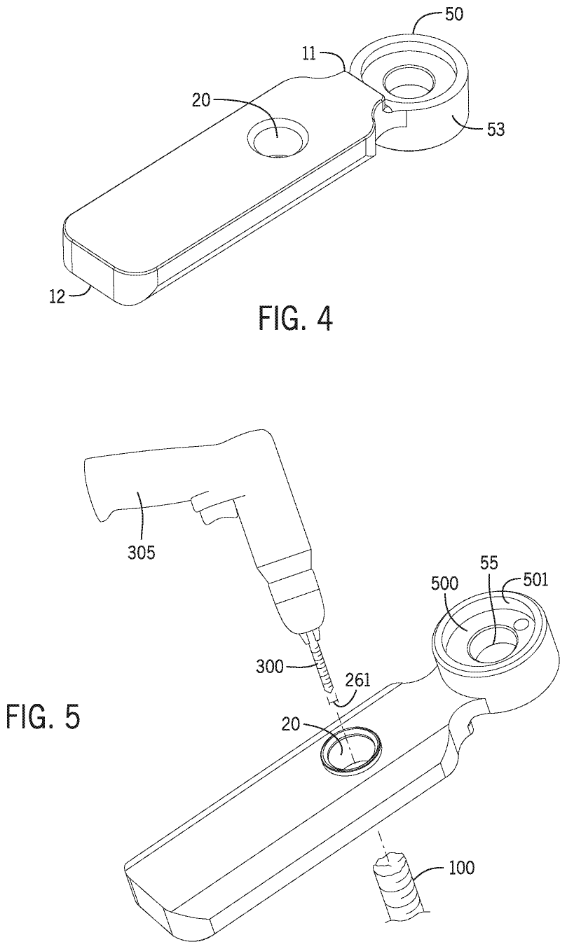

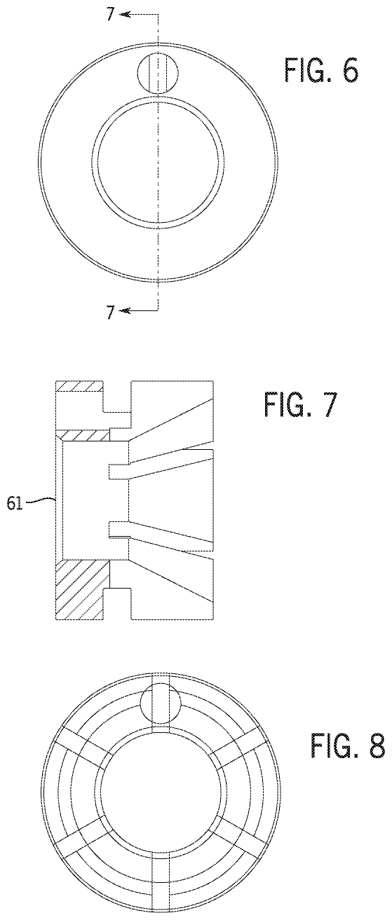

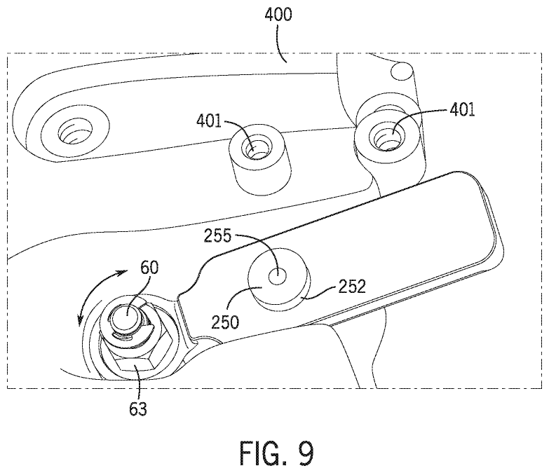

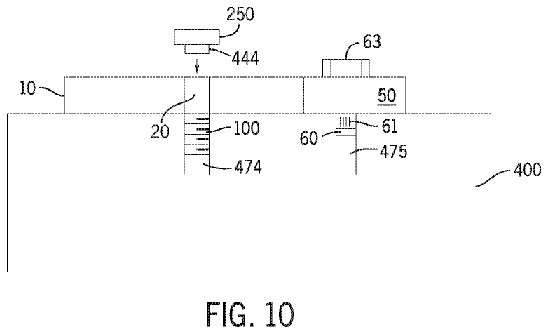

### DETAILED DESCRIPTION OF THE PREFERRED EMBODIMENTS

A valve cover repair tool is provided. The tool allows a user to remove a broken hold down bolt from an engine valve cover without damaging the valve cover. The valve cover repair tool has an elongated neck portion and a generally circular expander flange portion. An alignment hole may be located on the elongated neck portion. A screw and an expander nut may be secured within the generally circular expander portion. When the nut is turned, the expander flange may expand within an opening of a valve cover. Once the tool is secured, a drill is then used in the alignment hole to remove the broken hold down bolt.

With the passage of time and the effect of corrosion, an injector hold-down bolt or an injector hold-down bolt hole can degrade to the point where they fracture or otherwise become damaged. For instance, during repairs when a technician attempts to unscrew an injector hold-down bolt, the injector hold-down bolt may break or the threads within an injector hold-down bolt hole can be damaged. In these instances, it may become necessary to drill out the damaged injector hold-down bolt from the injector hold-down bolt hole or to re-thread the injector hold-down bolt hole in order to repair engine.

In one embodiment of the invention, the present tool can be used to repair an injector hold-down bolt hole without having to remove either components or the entirety of engine from the vehicle. The tool may be comprised of a generally oval or ovoid shaped cylindrical plate, which is designed such that it is large enough to cover both a fuel injector hole and an injector hold-down bolt hole and to precisely align the two using existing exhaust valve components. At the same time, the tool is small enough to fit within the space around these holes and not interfere with other components in engine, such as valve springs. The tool is preferably made from a rigid material such as type 6061 hard-coated aluminum, although other rigid materials, such as carbon steel, stainless steel, other forms of aluminum, and dense polymers could also be used. The tool may be approximately 2.75″ long, 2″ wide, and ½″ thick. Other shapes and sizes of the plate can also fall within the scope of the invention, as long as they can enable plate to be attached to the fuel injector hole and to enable the repair of an injector hold-down bolt hole without interfering with other components inside the engine.

Referring now to the figures, in an embodiment a valve cover repair tool 1 is provided. The valve cover repair tool 1 has an elongated neck portion 10 and a generally circular expander portion 50. The elongated neck portion 10 is generally flat. The elongated neck portion 10 may have a first end 11, a second end 12, a first side 13, a second side 14, a top 15 and a bottom 16. The generally circular expander portion 50 has a top 51, a bottom 52, a generally circular side 53 and a second opening 55 (FIG. 5). In an embodiment, the second opening 55 is larger than the first opening 20. The first end 11 of the elongated neck portion 10 is connected to the generally circular side 53 of the generally circular expander portion 50. A first opening 20 may be located on the elongated neck portion 10. The first opening 20 may allow for the alignment of a drill bit 300 of a drill 305 to drill out a broken bolt 100 (e.g. hold down bolt) which is stuck in an opening 401 of an engine 400.

In an embodiment, the second opening 55 may have a generally circular ledge 500 located within the interior side walls 501 of the second opening 55. The generally circular ledge 500 may secure the screw 60, an expanding flange 61, a washer 62, a nut 63 and an e-style ring 64 to the tool 1. The generally circular ledge 500 has a smaller diameter than the diameter of the second opening 55 at the top and bottom of the generally circular opening 55. As a result, the generally circular ledge 500 may secure the nut 63 on the opposite side of the generally circular ledge 500 than the top of the screw 60.

An optional and removable generally circular drill alignment piece 250 may be partially inserted into the first opening 20. The drill alignment piece may have a top 251, a bottom (not shown), a side 252, and an opening 255. The side 252 of the circular alignment piece 252 may have a knurled edge for allowing a user to manually screw and secure the circular drill alignment piece 250 into the first opening (or hole) 20 of the tool 1. The circular drill alignment piece 250 may have an extended interior ledge 444 on its bottom. The extended interior ledge 444 is circular and has a diameter substantially equal to the diameter of the first opening 20 so that the extended interior ledge may be screwed into the first opening 20.

In one embodiment, the first opening 20 and the extended interior ledge of the circular alignment piece 250 have corresponding threaded members (not shown) which allows the extended interior ledge of the circular drill alignment piece 250 to be temporarily screwed into the first opening 20. In an embodiment, the circular opening 255 of the circular drill alignment piece 250 has a diameter 260 which is slightly greater than a diameter 261 of the drill bit 300 which is used to drill out the broken bolt 100. The circular drill alignment piece 250 may be swapped out for an alternative circular drill alignment piece 250 with a different sized opening 255 depending on the size of the drill 300 that is needed for the job. Ideally, the diameter 261 of the drill bit 300 is only slightly smaller than the diameter 260 of the opening 255 of the circular drill alignment piece 250 so that the drill bit 300 does not move (other than rotating) while in use. As a result, the drill 305 is perfectly positioned and aligned above the broken bolt 100 during use.

Located within or passing through a second opening 55 of the generally circular expander portion 50 may be a screw 60, an expanding flange 61, a washer 62, a nut 63 and an e-style ring 64. During a method of use, the screw 60 and expanding flange 61 may be placed in and secured to an opening 475 of the cylinder head of an engine. Turning the nut 63 moves the screw 60 therein either expanding or contracting the expanding flange 61. To use the tool, a user first places the portion of the tool 1 with the screw 60 into an engine opening 475 of the engine cylinder head 400 which is next to a broken bolt 100 which is stuck in an adjacent hole in the engine cylinder head 400. The user then turns the nut 63 which therein causes the expander flange 61 of the tool 1 to expand its diameter 66. When the expander flange 61 is expanded while inside the engine opening, the tool 1 becomes secured to the engine cylinder head 400 in the opening next to the opening which contains the broken bolt 100.

The user then inserts the generally circular drill alignment piece 250 into first opening 20 of the tool 1 and, in one embodiment, screws the generally circular drill alignment piece 250 partially into the first opening 20 of the tool 1 by means of the threaded member located within the first opening 20. Once the generally circular drill alignment piece 250 is secured to the first opening 20 and the tool 1 is secured to the engine cylinder head 400 by means of the expander flange 61 being secured within an adjacent engine opening, the drill bit 300 may be inserted completely through the hole 255 of the generally circular drill alignment piece 250 so that it contacts the broken bolt 100.

The drill bit 300 may then act on the broken bolt 100 located in one of the holes of the engine cylinder head 400 to break up the broken bolt 100 and fully remove it from the engine cylinder head 400 so that a new, unbroken bolt may be used. Ideally, the dill 300 partially drills out the broken bolt 100 and then the first opening 20 is flushed to remove the pieces of the drilled out broken bolt 100. The process is repeated until the entire broken bolt 100 is removed. After use, the nut 63 is turned in the opposite direction to decrease the diameter 66 of the expander flange 61 so that the tool 1 may be removed from the engine cylinder head 400. A new bolt may then be inserted into the opening 474 that previously housed the broken bolt 100.

Although embodiments of the invention are shown and described therein, it should be understood that various changes and modifications to the presently preferred embodiments will be apparent to those skilled in the art. Such changes and modifications may be made without departing from the spirit and scope of the invention and without diminishing its attendant advantages.

I claim:

1. A valve cover repair tool comprising:
an elongated neck portion having a first end and a second end;
a first opening; and
a second opening wherein the second opening has a generally circular expander portion having a screw, a flange and a nut secured to the second opening.

2. The valve cover repair tool of claim 1 wherein the first opening is located between the first end and the second end of the elongated neck portion.

3. The valve cover repair tool of claim 1 wherein the flange has a diameter.

4. The valve cover repair tool of claim 3 wherein the diameter of the flange may expand or contract upon the turning of the nut.

5. The valve cover repair tool of claim 1 further comprising:
a removable circular alignment piece.

6. The valve cover repair tool of claim 5 wherein the circular alignment piece is removably secured to the first opening of the elongated neck portion.

7. The valve cover repair tool of claim 5 wherein the circular alignment piece has an opening and wherein the opening has a diameter.

8. The valve cover repair tool of claim 5 wherein the circular alignment piece has a threaded member which correspondingly mates with a threaded member of the first opening of the elongated neck piece.

9. The valve cover repair tool of claim 1 wherein the first opening is smaller than the second opening.

10. A method for repairing a broken bolt of a valve cover comprising the steps of:
providing an elongated neck portion having a first end, a second end, a top and a bottom;
providing a first opening;
providing a second opening wherein the second opening has a generally circular expander portion having a screw, a flange and a nut secured to the second opening;
inserting a drill bit is inserted into the first opening to drill a broken bolt located under the bottom of the elongated neck portion.

11. The method for repairing a broken bolt of a valve cover of claim 10 further comprising the steps of:
providing a circular drill alignment piece wherein the circular drill alignment piece has an opening and therein the circular drill alignment piece is temporarily secured to the first opening.

12. The method for repairing a broken bolt of a valve cover of claim 11 further comprising the steps of:
providing an opening in the circular drill alignment piece and wherein the drill bit passes through the opening of the circular drill alignment piece.
